(19) United States
(12) Patent Application Publication
(10) Pub. No.: US 2009/0192692 A1
(43) Pub. Date: Jul. 30, 2009

(54) Method and Device for Operating a Drive Unit

(75) Inventors: Dirk Hartmann, Stuttgart (DE); Werner Mezger, Eberstadt (DE); Andreas Roth, Muehlacker-Lomersheim (DE); Juergen Rappold, Ilsfeld-Auenstein (DE); Georg Mallebrein, Korntal-Muenchingen (DE); Nikolas Poertner, Stuttgart (DE); Henri Barbier, Schwieberdingen (DE); Ingo Fecht, Ludwigsburg (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/991,336

(22) PCT Filed: Aug. 1, 2006
(86) PCT No.: PCT/EP2006/064911

§ 371 Date: Mar. 6, 2009

(30) Foreign Application Priority Data
Sep. 9, 2005 (DE) 10 2005 042 846.0

(51) Int. Cl. F02D 17/02

(52) U.S. Cl. 701/102

(57) ABSTRACT

A method and a device are provided for operating a drive unit of a vehicle having an engine which in a first operating state is operated with a first number of cylinders and in a second operating state is operated with a second number of cylinders. The first number of cylinders and the second number of cylinders are different from one another. The switchover of the engine between the first operating state and the second operating state is adapted to the driver type or the driving situation. Switchover between the first operating state and the second operating state is delayed as a function of the driver type or the driving situation.

### BACKGROUND OF THE INVENTION

1. Field of the Invention

The present invention relates to a method and a device for operating a drive unit of a vehicle.

2. Description of Related Art

Methods are known for operating a drive unit of a vehicle having an engine which in a first operating state is operated with a first number of cylinders and in a second operating state is operated with a second number of cylinders, the first number of cylinders and the second number of cylinders being different from one another. In so-called half-engine operation, half of the cylinders in the engine are disconnected by switching off the intake valves and exhaust valves as well as the injection. Half-engine operation may be designed as cylinder disconnection or bank disconnection. In the former case, half of the cylinders are disconnected, regardless of which engine bank they are located on. In the latter case, half of the engine banks are disconnected, this likewise corresponding to a disconnection of half of the cylinders in the engine, since all engine banks have the same number of cylinders. On the other hand, in full-engine operation all cylinders are in operation.

### A BRIEF SUMMARY OF THE INVENTION

In contrast, the method according to the present invention and the device according to the present invention for operating a drive unit of a vehicle have the advantage that in the case of an engine which in a first operating state is operated with a first number of cylinders and in a second operating state is operated with a second number of cylinders, the first number of cylinders and the second number of cylinders being different from one another, switchover of the engine between the first operating state and the second operating state is delayed as a function of a driver type or a driving situation. In this manner, switchover of the engine between the first operating state and the second operating state may be delayed differently for different driver types or for different driving situations. Thus, the operation of the engine is better adapted to the instantaneous driver type or the instantaneous driving situation.

Different delays in switchover of the engine between the first operating state and the second operating state may be set in a particularly simple manner via a different hysteresis for at least one switch threshold of an operating variable for the drive unit.

A further simple possibility for implementing different delays in switchover of the engine between the first operating state and the second operating state results when these different delays are set via a different delay in implementing a switch request.

It is also advantageous when the delay for a sporty driver is selected to be greater than for an economical driver. In this manner a requested engine power may be ensured more quickly for a sporty driver than for an economical driver.

It is similarly advantageous when the delay for downhill driving is selected to be less than for uphill driving. In this manner a requested engine power may be ensured more quickly for uphill driving than for downhill driving.

It is similarly advantageous when the delay for operation with a trailer is selected to be greater than for operation without a trailer. In this case as well, higher engine power may be ensured for operation with a trailer than for operation without a trailer.

### A BRIEF DESCRIPTION OF THE SEVERAL VIEWS OF THE DRAWING

FIG. 1 shows a diagram of the engine torque plotted against the engine speed for illustrating various switch thresholds for switching over between various operating states of an engine with different numbers of cylinders in operation.

FIG. 2 shows a block diagram of a device according to the present invention.

FIG. 3 shows a flow diagram of a method according to the present invention.

### DETAILED DESCRIPTION OF THE INVENTION

The present invention provides a method and a device for operating a drive unit of a vehicle having an engine which in a first operating state is operated with a first number of cylinders and in a second operating state is operated with a second number of cylinders, the first number of cylinders and the second number of cylinders being different from one another. The engine may, for example, be a spark ignition engine or a diesel engine. In the following description it is assumed, without limitation of universality, that the first operating state is the so-called half-engine operation in which half of the cylinders of the engine are disconnected by switching off the intake valves and exhaust valves as well as the fuel injection. The half-engine operation may be designed as cylinder disconnection or bank disconnection. In the former case of cylinder disconnection, half of the cylinders are disconnected in the described manner, regardless of which engine bank they are located on, for the case that the engine has multiple engine banks. If the engine has an even number of engine banks, each having the same number of cylinders, in the case of bank disconnection half-engine operation means that half of the engine banks are disconnected, all cylinders of the disconnected banks being disconnected by switching off the intake valves and exhaust valves as well as the fuel injection. In the present example, the second operating state is intended to be full-engine operation, in which all cylinders of the engine are operated; i.e., no cylinders are disconnected.

For implementing the present invention, the choice of the first number of cylinders operated in the first operating state of the engine and the choice of the second number of cylinders operated in the second operating state of the engine are totally irrelevant, provided that the first number of cylinders and the second number of cylinders are different from one another.

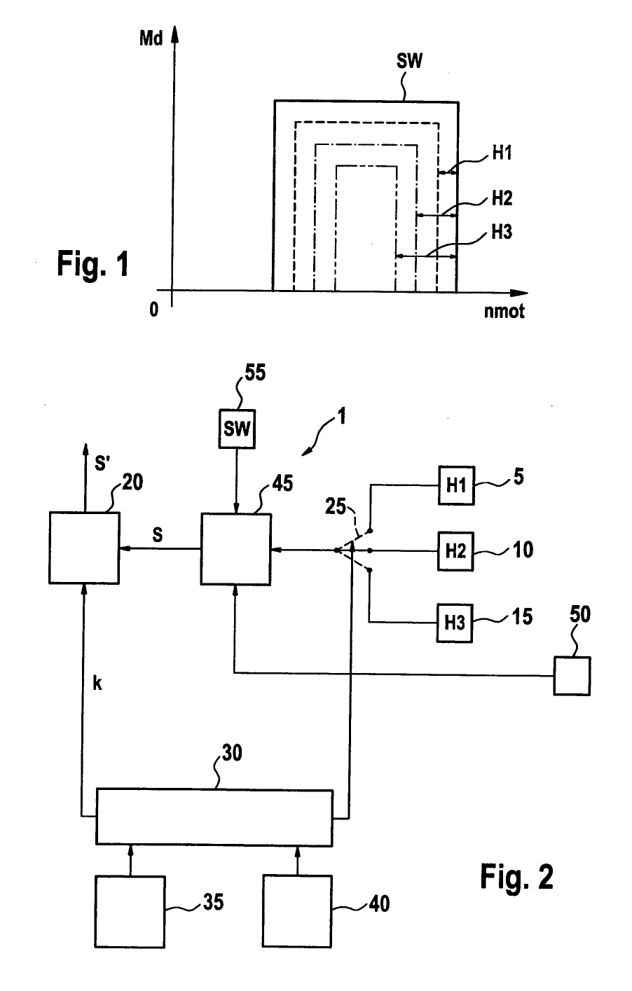

Depending on engine torque Md and engine speed nmot, there is a first operating range of the drive unit, i.e., the engine, in which the engine is to be operated in the first operating state, and a second operating range in which the engine is to be operated in the second operating state. As illustrated in FIG. 1, the two operating ranges are separated from one another by a switch threshold SW, the engine being switched between the first operating state and the second operating state when operation exceeds or falls below switch threshold SW. This is explained in greater detail below, using the example of half-engine operation and full-engine operation.

Half-engine operation is possible only in a limited operating range. Thus, for half-engine operation there is an upper boundary for possible engine torque Md and a lower and upper boundary for engine speed nmot, as represented by switch threshold SW in FIG. 1. The engine may and should be operated in half-engine mode within the first operating range formed by switch threshold SW. Outside the first operating state encompassed by switch threshold SW the engine is in the second operating state, and must be operated in full-engine mode. During the transition from the second operating range to the first operating range the engine is switched from full-engine operation to half-engine operation. During the transition from the first operating range to the second operating range the engine is switched from half-engine operation to full-engine operation. To prevent undesirable oscillatory switching, i.e., back-and-forth switchover between full-engine operation and half-engine operation, for switch threshold SW when the corresponding operating variable for engine torque Md or engine speed nmot fluctuates slightly about switch threshold SW, switch threshold SW is debounced via hystereses or temporal delays for determining whether a switch should be made between full-engine operation and half-engine operation.

In the software for the transmission controller of the vehicle as well as in the software for the engine controller of the vehicle, functions may be present which recognize a driver type or a driving situation. Thus, for example, the transmission shift points are raised for a sporty driver and are lowered for an economical driver. The shifting process for the sporty driver is thus delayed compared to the economical driver. A similar procedure is followed for uphill or downhill driving; i.e., the transmission shift points are raised if uphill driving is recognized and are lowered if downhill driving is recognized. Furthermore, in some vehicles a so-called sport switch may be provided, which upon actuation sets a more sporty driving response, for example for the engine control unit or the chassis.

According to the present invention, the driver type or the driving situation is taken into account in the debouncing of switch threshold SW in the event of a request to switch between full-engine operation and half-engine operation. Provided that the subject in question is the switchover between full-engine operation and half-engine operation, this refers to switching over from full-engine operation to half-engine operation as well as to switching over from half-engine operation to full-engine operation.

FIG. 2 illustrates a block diagram of a device according to the present invention. This device is identified by reference numeral 1. Device 1 may be implemented as software and/or hardware in an engine controller for the vehicle. The device includes a first hysteresis memory 5 in which a first hysteresis distance Hl is stored, a second hysteresis memory 10 in which a second hysteresis distance H2 is stored, and a third hysteresis memory 15 in which a third hysteresis distance H3 is stored. In the present example three different hysteresis distances H1, H2, H3 have been selected, although for the present invention it is sufficient to select at least two different hysteresis distances; depending on the driving situation or driver type to be differentiated, any given number of different hysteresis distances are also possible. For the sake of simplicity and as illustrated in FIG. 1, it is assumed that any hysteresis distance H1, H2, H3 is applied to the upper engine torque boundary as well as to the lower boundary of the engine speed and the upper boundary of the engine speed, so that, so to speak, a symmetrical hysteresis distance results at the three boundaries of switch threshold SW illustrated in FIG. 1. In a very general sense, however, in each of hysteresis memories 5, 10, 15 three hysteresis distances that are different from one another may be stored, with one individual boundary of the three boundaries of switch threshold SW in FIG. 1 each being associated with one hysteresis distance. The three hysteresis distances stored in a hysteresis memory 5, 10, 15 may have different sizes, although at least two hysteresis distances in a hysteresis memory 5, 10, 15 may also be the same size. For the sake of simplicity, as an example it is assumed below that only one hysteresis distance, which is equal for all three boundaries of switch threshold SW, is stored in each of hysteresis memories 5, 10, 15. The content of one of hysteresis memories 5, 10, 15 is supplied via a controlled switch 25 to a comparison unit 45, depending on the switch position. Comparison unit 45 is also supplied with the instantaneous operating point of the engine with regard to engine torque Md and engine speed nmot by an operating variable detection unit 50, these operating variables being detected in a manner known to one skilled in the art, and operating variable detection unit 50 symbolically representing the sensor system or modeling necessary for this purpose. Comparison unit 45 is also supplied with threshold value SW according to FIG. 1 by a threshold value memory 55, the threshold value being specified in a fixed manner, the same as for hysteresis distances H1, H2, H3 in hysteresis memories 5, 10, 15. Threshold value SW and hysteresis distances H1, H2, H3 may be applied on a test bench, for example.

Comparison unit 45 then compares the operating point of the engine supplied to operating variable detection unit 50 with threshold value SW, in a manner known to one skilled in the art and taking into account the hysteresis distance supplied via controlled switch 25. FIG. 1 shows that first hysteresis distance Hi is smaller than second hysteresis distance H2, and second hysteresis distance H2 is smaller than third hysteresis distance H3. By virtue of the hysteresis distance selected by controlled switch 25 the switchover from full-engine operation to half-engine operation is delayed, since the lower boundary of engine speed nmot to be exceeded is raised by the selected hysteresis distance, or the upper boundary of engine speed nmot below which the engine speed is to remain is lowered by the selected hysteresis distance, or the upper boundary of engine torque Md below which the engine torque is to remain is lowered by the selected hysteresis distance. The larger the selected hysteresis distance, the greater the delay in switching over from full-engine operation to half-engine operation in comparison to threshold value SW. Conversely, switchover is performed from half-engine operation to full-engine operation when threshold value SW is exceeded. To avoid the problem of different magnitudes of engine speed nmot and engine torque Md in the case of a single hysteresis distance for all three boundaries of threshold value SW, as in the present example, the particular hysteresis distance may be stored in hysteresis memories 5, 10, 15 as a percentage of the particular boundary of threshold value SW. Thus, it is possible, for example, to displace hysteresis distance Hi inward at all three boundaries by 3%, second hysteresis distance H2 inward by 5%, and third hysteresis distance H3 inward by 7% with respect to threshold value SW, resulting in the qualitative configuration of the hysteresis thresholds in comparison to the switch threshold as shown in FIG. 1. The resulting hysteresis threshold having first hysteresis distance H1 is shown by dashed lines in FIG. 1, the hysteresis threshold linked to second hysteresis distance H2 is shown by dashed-dotted lines, and the hysteresis threshold linked to third hysteresis distance H3 is shown by dashed-double dotted lines in FIG. 1. Via a lower boundary for the engine speed, an upper boundary for the engine speed, and an upper boundary for the engine torque, the particular hysteresis threshold in turn encloses an operating range within the first operating range, which becomes smaller the larger the magnitude that is selected for the hysteresis distance.

Starting from full-engine operation, if operating variable detection unit 50 detects an operating point of the engine with respect to engine torque Md and engine speed nmot which is situated within the operating range that is delimited by the hysteresis threshold of the selected hysteresis distance, a switch request S is generated by comparison unit 45 for switching over from full-engine operation to half-engine operation. This switch request S is sent to a delay element 20, the delay time of which is provided by a delay time constant k. Thus, switch request S, which is time-delayed by time constant k, is delivered by delay element 20 as resulting switch request S′ and initiates switchover from full-engine operation to half-engine operation. Device 1 also includes a delay unit 30. Delay unit 30 receives information from a driver type detection unit 35 concerning the instantaneous driver type, and/or receives information from a driving situation detection unit 40 concerning the instantaneous driving situation. Driver type detection unit 35 and driving situation detection unit 40 may be provided in a manner known to one skilled in the art. In FIG. 2, driver type detection unit 35 and driving situation detection unit 40 are purely schematic representations of driver type recognition and driving situation recognition known to one skilled in the art. The driver type recognition and/or driving situation recognition may be implemented in device 1 as illustrated in FIG. 2.

The driver type recognition and/or driving situation recognition may also be implemented outside device 1 in the form of an independent function block in the engine controller. The driver type recognition and/or driving situation recognition may also be performed in another control unit, for example the transmission control unit of the vehicle, and from there the corresponding information concerning the driver type and the driver situation is transmitted to delay unit 30 for device 1. The driver type recognition may also be provided, for example, by reading in information from switches installed in the vehicle, such as, for example, a sport switch in delay unit 30. Delay unit 30 controls switch 25 as a function of the recognized driver type and/or the recognized driving situation, so that for various driver types and/or driving situations in each case a different switch position is set, and a different hysteresis distance is thus selected. Additionally or alternatively, delay unit 30 may also set time constant k for delay element 20 as a function of the recognized driver type and/or the recognized driving situation, so that different time constants k may be set for different driver types and/or driving situations.

According to the example corresponding to FIG. 2, the debouncing, i.e., delay, of the switchover from full-engine operation to half-engine operation is achieved by use of a selected hysteresis distance as well as by delayed implementation of the switch request. Alternatively, this debouncing may be carried out only by use of the selected hysteresis distance, so that delay element 20 is not necessary and switch request S is directly implemented. Alternatively, the described debouncing or delay during switchover from full-engine operation to half-engine operation may also be achieved by the delayed implementation of switch request S via delay element 20 and time constants k, so that in this case no hysteresis distance is necessary, and the switchover from full-engine operation to half-engine operation as well as from half-engine operation to full-engine operation is directly requested when operation falls below threshold value SW in FIG. 1, or when threshold value SW is exceeded.

It is assumed below that the debouncing occurs as a function of the driver type and/or the driving situation by use of the various hysteresis distances H1, H2, and H3. Delay unit 30 actuates switch 25 for selecting first hysteresis distance H1 in the case where the recognized instantaneous driver type and/or the recognized instantaneous driving situation in general requires a comparatively low engine power, or in general do not require a requested engine power as quickly as possible. This may be the case, for example, for an economical driver or for downhill driving. Delay unit 30 actuates switch 25 for selecting second hysteresis distance H2 when the instantaneously recognized driver type and/or the instantaneously recognized driving situation generally requires a requested engine power more quickly in comparison to the previous case. This may be the case, for example, for a sporty driver type, or for a recognized operation of the vehicle with a trailer, or for recognized uphill driving. Delay unit 30 actuates switch 25 for selecting third hysteresis distance H3 in the case where the instantaneously recognized driver type and/or the instantaneously recognized driving situation generally requires a requested engine power more quickly in comparison to the previously described case. This may be the case, for example, for a recognized sporty driver and simultaneously recognized uphill driving, or for a recognized sporty driver and simultaneously recognized driving operation with a trailer, or for recognized driving operation of the vehicle with a trailer and simultaneous uphill driving. As described, further differentiation requires that additional hysteresis distances be provided, so that more than three different hysteresis distances are then used.

When switch request S is additionally or alternatively performed by use of delay element 20 and time constants k, delay unit 30 sets a first time constant k1 as the instantaneous driving situation in the described exemplary case of the economical driver type or downhill driving. In the second described exemplary case of the recognized sporty driver type, or the instantaneous driving situation with recognized trailer operation, or with recognized uphill driving, delay unit 30 sets a second time constant k2. In the third described exemplary case of the instantaneously recognized sporty driver type and the instantaneously recognized driving situation of uphill driving, or the instantaneously recognized sporty driver type and the instantaneously recognized driving situation of trailer operation, or the instantaneously recognized driving situation of uphill driving and trailer operation, delay unit 30 sets a third time constant k3. Thus, k3>k2>k1.

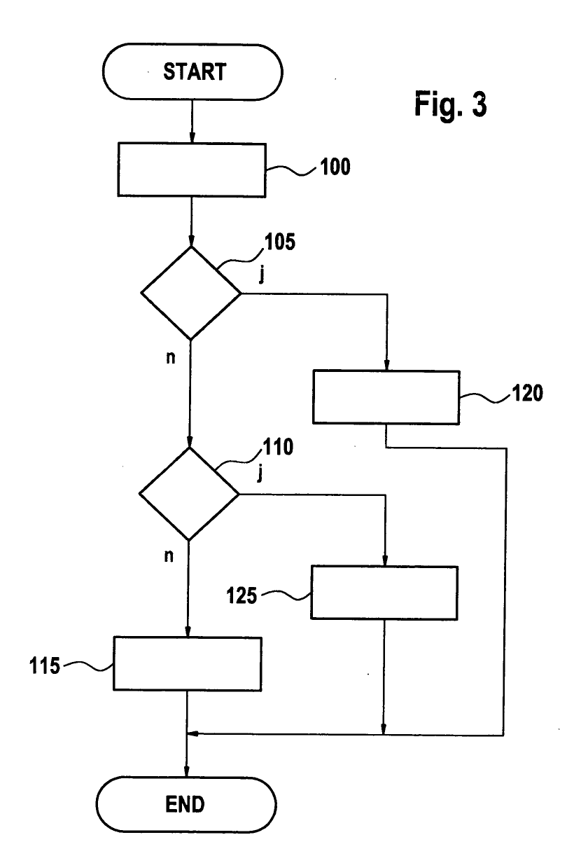

FIG. 3 illustrates a flow chart for an example of a sequence of the method according to the present invention. After the program starts, driver type detection unit 35 determines the instantaneous driver type, and driving situation detection unit 40 determines the instantaneous driving situation of the vehicle. The program subsequently branches to a point 105.

At program point 105, delay unit 30 checks whether the instantaneously recognized driver type is an economical driver type, or whether the instantaneous driving situation represents downhill driving. If this is the case, the program branches to a point 120; otherwise it branches to a point 110.

At program point 120, delay unit 30 induces switch 25 to select first hysteresis distance H1. Additionally or alternatively, delay unit 30 sets time constant k for delay element 20 to first value k1. The program is then terminated.

At program point 110, delay unit 30 checks whether the instantaneously recognized driver type is a sporty driver type, or whether the instantaneously recognized driving situation is characterized by trailer operation or uphill driving. If this is the case, the program branches to a point 125; otherwise it branches to a point 115.

At program point 125, delay unit 30 induces switch 25 to select second hysteresis distance H2. Additionally or alternatively, delay unit 30 sets time constant k for delay element 20 to second value k2. The program is then terminated.

At program point 115, delay unit 30 induces switch 25 to select third hysteresis distance H3. Additionally or alternatively, at program point 115 delay unit 30 sets time constant k for delay element 20 to third value k3. The program is then terminated.

The recognition of the driver type may be performed, for example, by evaluation of the temporal gradients of the gas pedal actuation. If this gradient exceeds a predetermined threshold, a sporty or less economical driver type is recognized, and if this gradient is less than the threshold, the driver type is recognized as an economical or less sporty driver type. To this end, the threshold may suitably be applied on a test bench. Correspondingly, the sporty driver type may be recognized when a sport button or a sport switch is present, and this sport button or sport switch is actuated. In general, a distinction may be made between different sporty driver types or different economical driver types as a function of the temporal gradients of the gas pedal actuations. To this end, for example, multiple threshold values may be defined for the temporal gradients of the gas pedal actuations, so that a distinction may be made between more than two different sporty driver types or more than two different economical driver types. Trailer operation may be recognized, for example, by use of a switching circuit which is closed when a trailer is attached to the trailer hitch of the vehicle, and is open when no trailer is attached to the trailer hitch. Corresponding to the open or closed switching circuit, a different voltage may be relayed as a signal for operation with a trailer or without a trailer to delay unit 30. Uphill driving or downhill driving may, for example, be recognized by use of an inclination sensor in a manner known to one skilled in the art. In the previously described example a distinction was made between the economical driver type and the sporty driver type. The present invention may be correspondingly applied to additional driver types to be defined and detected, and in the same way may be applied to additional driving situations to be defined and detected.

In the exemplary embodiment previously described, both the instantaneous driver type and the instantaneous driving situation were considered for the selection of the hysteresis distance or the time constants. As an alternative it is also possible to consider only the driver type or only the driving situation.

By use of the present invention, the switchover from full-engine operation to half-engine operation is adapted to the instantaneous driver type and/or to the instantaneous driving situation, thereby reducing the number of unnecessary switching operations, depending on the driver type or driving situation. As a result of the described hysteresis distances, the number of unnecessary switching operations is reduced depending on the driver type or driving situation, thus avoiding increased fuel consumption and reduced driving comfort.

In the previously described exemplary embodiment it was stated that in switching over from full-engine operation to half-engine operation, starting from threshold value SW, the selected hysteresis distance must be taken into account, and the switchover from half-engine operation to full-engine operation is achieved directly on crossing over threshold value SW. The present invention may also be applied correspondingly for the converse case, for which in the switchover from half-engine operation to full-engine operation, starting from threshold value SW, the correspondingly selected hysteresis distance must be taken into account, whereas the switchover from full-engine operation to half-engine operation is achieved directly on crossing over threshold value SW. This would be meaningful, for example, for an economical driver who wants to remain in the fuel-saving half-engine operation for as long as possible. In this case the hysteresis distance, for example, would be set larger the more economical the driver type, or the hysteresis distance would be set smaller the sportier the driver type, possibly reduced to zero.

According to a third embodiment, for the switchover from full-engine operation to half-engine operation as well as the switchover from half-engine operation to full-engine operation it is possible for the switchover, starting from threshold value SW, to occur only by taking the selected hysteresis distance into account.

Correspondingly, the delayed implementation of switch request S by use of time constant k may also be taken into account, as described, in the switchover from full-engine operation to half-engine operation. Additionally or alternatively, it may also be taken into account in the switchover from half-engine operation to full-engine operation.

Here, the driver type identifies the manner in which the driver drives the vehicle, i.e., whether he accelerates more or less intensely, or brakes more or less intensely, or whether he initiates gear shifting early or late. With regard to the magnitude of the delay in switchover of the engine between full-engine operation and half-engine operation, of particular interest is the effect of driver response, i.e., the driver type, on the engine power required for implementing this driver response. The same applies for the driving situation, which in this case refers to external influences, independent of the driver, on the driving response of the vehicle. These influences as well are taken into account with regard to their effect on the delay in switching over between half-engine operation and full-engine operation, in particular with respect to the required engine power associated with them. In addition to the described external influences of trailer operation and the roadway slope, further influencing variables such as relative wind, in particular headwind, road traction of the vehicle, in particular for a wet or icy roadway, etc., may be taken into account.

1-7. (canceled)

8. A method for operating a drive unit of a vehicle having an engine, comprising:
operating the engine with a first number of cylinders in a first operating state;
operating the engine with a second number of cylinders in a second operating state, wherein the first number of cylinders and the second number of cylinders are different from one another; and
performing a switchover of the engine between the first operating state and the second operating state, wherein the timing of the switchover is delayed as a function of a driver type or a driving situation.

9. The method as recited in claim 8, wherein different delays in the switchover of the engine between the first operating state and the second operating state are specified by correspondingly different hystereses for a switch threshold of an operating variable for the drive unit.

10. The method as recited in claim 8, wherein different delays in the switchover of the engine between the first operating state and the second operating state are specified by correspondingly different delays in implementing a switchover request.

11. The method as recited in claim 8, wherein a delay of the switchover for a sporty driver is specified to be greater than a delay of the switchover for an economical driver.

12. The method as recited in claim 8, wherein a delay of the switchover for downhill driving is specified to be less than a delay of the switchover for uphill driving.

13. The method as recited in claim 8, wherein a delay of the switchover for vehicle operation with a trailer is specified to be greater than a delay of the switchover for vehicle operation without a trailer.

14. A device for operating a drive unit of a vehicle having an engine, comprising:
a delay arrangement configured to selectively delay the timing of a switchover of the engine between a first operating state and a second operating state, wherein the timing of the switchover is delayed as a function of a driver type or a driving situation;
wherein the engine is operated with a first number of cylinders in the first operating state, and wherein the engine is operated with a second number of cylinders in the second operating state, the first number of cylinders and the second number of cylinders are different from one another.
